(19) United States
(12) Patent Application Publication
(10) Pub. No.: US 2024/0030589 A1
(43) Pub. Date: Jan. 25, 2024

(54) ANTENNA MODULE AND ELECTRONIC DEVICE COMPRISING SAME

(71) Applicant: SAMSUNG ELECTRONICS CO., LTD., Suwon-si (KR)

(72) Inventor: Eunseok HONG, Suwon-si (KR)

(73) Assignee: SAMSUNG ELECTRONICS CO., LTD., Suwon-si (KR)

(21) Appl. No.: 18/374,388

(22) Filed: Sep. 28, 2023

Related U.S. Application Data
(63) Continuation of application No. PCT/KR22/04735, filed on Apr. 1, 2022.

(30) Foreign Application Priority Data
Apr. 5, 2021 (KR) 10-2021-0044120

(51) Int. Cl. H01Q 1/24; H01Q 1/38; H01Q 9/04

(52) U.S. Cl. CPC H01Q 1/243; H01Q 1/38; H01Q 9/0407

(57) ABSTRACT

Disclosed is an electronic device including a housing, a support member, a printed circuit board, an antenna, and a processor. The antenna structure comprises: a first conductive patch disposed on a first layer and electrically connected to the first transmission line; a second conductive patch disposed to be spaced apart from the first conductive patch in the first layer and electrically connected to the second transmission line; a third conductive patch disposed spaced apart from the first conductive patch and the second conductive patch in the first layer and electrically connected to the third transmission line; and a shielding member disposed on the second layer, and the processor may be set to receive a wireless signal of a designated band by supplying power to the first conductive patch, the second conductive patch, and the third conductive patch by using a wireless communication circuit.

### CROSS-REFERENCE TO RELATED APPLICATIONS

This application is a bypass continuation application of International Application No. PCT/KR2022/004735, filed on Apr. 1, 2022, which is based on and claims priority to Korean Patent Application No. 10-2021-0044120, filed on Apr. 5, 2021, in the Korean Intellectual Property Office, the disclosures of which are incorporated by reference herein in their entireties.

### BACKGROUND

### 1. Field

The disclosure relates to an antenna module and an electronic device including the same.

### 2. Description of Related Art

With the development of mobile communication technology, electronic devices having at least one antenna are widely disseminated. Electronic devices may transmit and/or receive radio frequency (RF) signals including a voice signal or data (e.g., message, image, video, music file, or game) using an antenna.

An antenna may simultaneously transmit and receive signals belonging to different frequency bands by using a plurality of frequency bands. Electronic devices may provide a service of a global communication band by using signals belonging to different frequency bands. For example, electronic devices may perform communication (e.g., GPS, legacy, WiFi1) using a signal belonging to a low frequency band (LB) and/or communication (e.g., WiFi2) using a high frequency band (HB).

Meanwhile, electronic devices may transmit and receive signals using an antenna module including a plurality of components (e.g., patch antenna) in a housing. For example, a plurality of patch antennas included in an antenna module may be electrically connected to one portion of a printed circuit board so as to be fed. A patch antenna may be referred to as an antenna element that radiates or receives an RF signal of a specified frequency band (e.g., ultra-wide band (UWB)). Electronic devices may transmit and/or receive signals belonging to various frequency bands by using the above antenna module.

Electronic devices may include a plurality of antennas for transmitting and/or receiving signals of different frequency bands. Electronic devices may have a physical limitation in efficiently securing a frequency band in which a plurality of antennas transmit and receive. For example, a mounting space of electronic devices is physically limited, but components included in an antenna module may require a larger mounting space to efficiently perform a radiation operation.

Because the mounting space of electronic devices is limited, it may be difficult to secure an enough height of an antenna structure. For example, a patch antenna included in an antenna structure requires a specified height (or thickness) so as to exhibit optimum radiation efficiency. However, due to the above-mentioned limitation in a mounting space, particularly the limitation in height, it is difficult to implement an optimum lamination structure.

### SUMMARY

According to an aspect of the disclosure, an electronic device includes: a housing including: a first plate oriented in a first direction, a second plate oriented in a second direction opposite to the first direction, and a side member surrounding a space between the first plate and the second plate; a support member disposed in the space between the first plate and the second plate; a printed circuit board disposed on one surface of the support member and including a wireless communication circuit; an antenna disposed on the printed circuit board; and a processor operatively connected to the printed circuit board and the antenna, wherein the antenna includes: a first conductive patch disposed at a first layer and electrically connected to a first transmission line; a second conductive patch configured to be spaced apart from the first conductive patch at the first layer and electrically connected to a second transmission line; a third conductive patch configured to be spaced apart from the first conductive patch and the second conductive patch at the first layer, and electrically connected to a third transmission line; and a shielding member disposed at a second layer, and wherein the processor is configured to receive a wireless signal of a specified band by feeding the first conductive patch, the second conductive patch, and the third conductive patch using the wireless communication circuit.

The antenna may further include a dielectric disposed at a third layer that is between the first layer and the second layer.

The first conductive patch, the second conductive patch, and the third conductive patch may form a conductive pattern on a first surface, oriented in the first direction, of the dielectric disposed at the third layer.

The shielding member may be disposed on a second surface, oriented in the second direction, of the dielectric disposed at the third layer.

The first conductive patch, the second conductive patch, and the third conductive patch may have a square shape or a rectangular shape.

The shielding member may be a shield can.

The shielding member may be configured to be physically attached to the printed circuit board, and wherein the first conductive patch, the second conductive patch, and the third conductive patch are grounded by the shielding member.

The second conductive patch may be configured to be spaced a first separation distance apart from the first conductive patch in a third direction, and wherein the third conductive patch may be configured to be spaced a second separation distance apart from the first conductive patch in a fourth direction perpendicular to the third direction.

The antenna may further include a connection part electrically connected to the printed circuit board, the first transmission line, the second transmission line, and the third transmission line, and wherein the processor may be configured to feed the connection part using the wireless communication circuit.

The connection part may be configured to protrude from one side of the antenna when a rear plate may be provided in the first direction.

According to an aspect of the disclosure, an antenna includes: a plurality of layers; a first conductive patch disposed at a first layer among the plurality of layers and electrically connected to a first transmission line; a second conductive patch configured to be spaced apart from the first conductive patch in the first layer and electrically connected to a second transmission line; a third conductive patch configured to be spaced apart from the first conductive patch and the second conductive patch in the first layer, and electrically connected to a third transmission line; a shielding member disposed at a second layer among the plurality of layers; a connection part electrically connected to the first transmission line, the second transmission line, and the third transmission line; and a dielectric disposed at a third layer that may be a layer between the first layer and the second layer.

The first conductive patch, the second conductive patch, and the third conductive patch may have a square shape or a rectangular shape.

The shielding member may be a shield can.

One surface of the shielding member may be configured to be physically attached to a printed circuit board, and wherein the first conductive patch, the second conductive patch, and the third conductive patch are grounded by the shielding member.

The second conductive patch may be configured to be spaced a first separation distance apart from the first conductive patch in a third direction, and wherein the third conductive patch may be configured to be spaced a second separation distance apart from the first conductive patch in a fourth direction perpendicular to the third direction.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to one or more embodiments;

FIG. 2 is a front perspective view of an electronic device according to an embodiment;

FIG. 3 is a rear perspective view of an electronic device according to an embodiment;

FIG. 4 is an exploded perspective view of an electronic device according to an embodiment;

FIG. 5 is a plan view illustrating an interior of an electronic device according to an embodiment;

FIG. 6 is a perspective view illustrating an antenna structure and components included in the antenna structure according to an embodiment;

FIG. 7 is a conceptual diagram illustrating a laminate structure of an antenna structure according to an embodiment;

FIG. 8 is a conceptual diagram illustrating a laminate structure of an antenna structure according to an embodiment; and

FIG. 9 illustrates a radiation efficiency comparison table of an antenna structure according to an embodiment.

With respect to the description of the drawings, the same or similar reference signs may be used for the same or similar elements.

### DETAILED DESCRIPTION

Hereinafter, various embodiments of the disclosure will be described in detail with reference to the accompanying drawings. However, it should be understood that the disclosure is not limited to specific embodiments, but rather includes various modifications, equivalents and/or alternatives of the embodiments of the disclosure.

According to one or more embodiments of the disclosure, an electronic device may achieve improved radiation efficiency by mounting, based on a specified laminate structure, an antenna module including a plurality of components in a housing and may enable implementation of an antenna module of a relatively small size, and thus may be more free from a physical limitation in a mounting space.

Furthermore, the electronic device may more efficiently shield an electric signal using a shielding structure of a specified type (e.g., shield can) included in the above laminate structure. Moreover, the electronic device according to an embodiment of the disclosure may be implemented without requiring at least a portion of components included in the antenna module, thus strengthening price competitiveness during a product manufacturing process.

Various effects may be provided that are directly or indirectly identified through the disclosure.

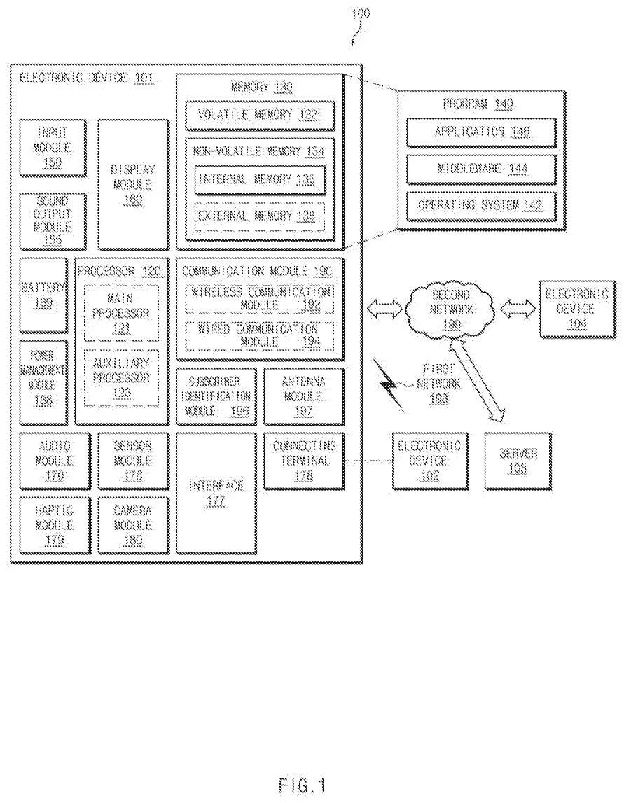

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102) According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order) It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

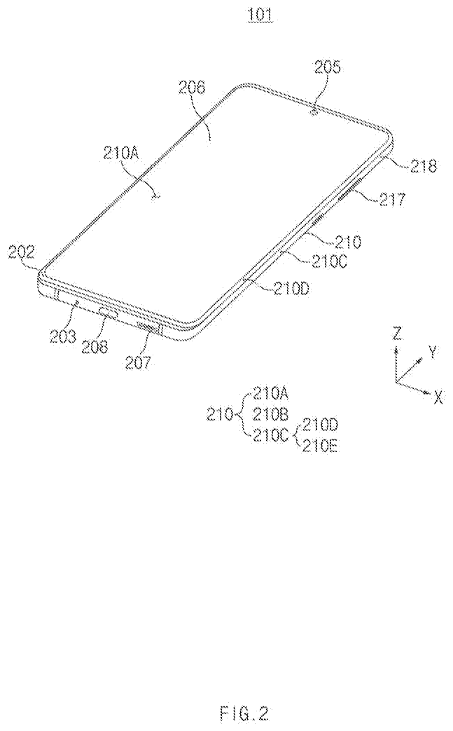

FIG. 2 is a front perspective view of an electronic device according to an embodiment.

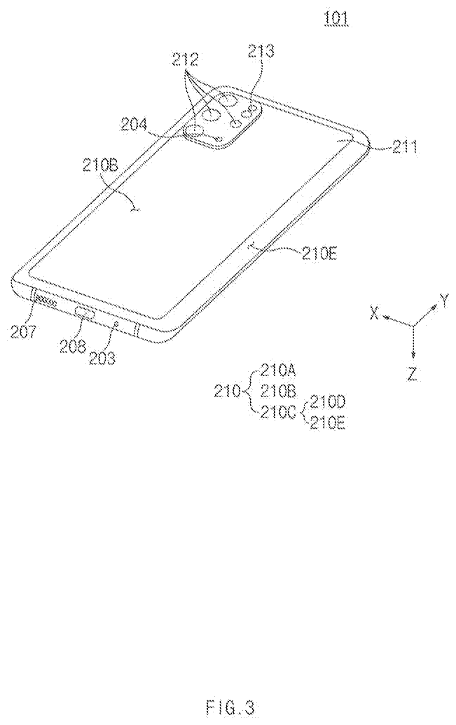

FIG. 3 is a rear perspective view of an electronic device according to an embodiment.

Referring to FIGS. 2 and 3, an electronic device 101 may comprise a housing 210 comprising a first surface (or front surface) 210A, a second surface (or rear surface) 210B, and a side surface 210C surrounding a space between the first surface 210A and the second surface 210B.

In another embodiment (not shown), the housing 210 may refer to a structure forming a portion of the first surface 210A, the second surface 210B, and the side surface 210C.

In an embodiment, the first surface 210A may be formed by a front plate 202 (e.g., a glass plate including various coating layers, or a polymer plate), at least a portion of which is substantially transparent. The second surface 210B may be formed by a rear plate 211 that is substantially opaque. The rear plate 211 may be formed by, for example, coated or colored glass, ceramic, polymer, metal (e.g., aluminum, stainless steel (STS), or magnesium), or a combination of at least two of the foregoing materials. The side surface 210C may be coupled to the front plate 202 and the rear plate 211, and may be formed by a side bezel structure (or “frame structure”) 218 including metal and/or polymer.

In another embodiment, the rear plate 211 and the side bezel structure 218 may be integrally formed and may include the same material (e.g., a metal material such as aluminum).

In the illustrated embodiment, the front plate 202 may include two first regions 210D that are bent and seamlessly extend from a partial region of the first surface 201A towards the rear plate 211. The first regions 210D may be disposed on both ends of a long edge of the front plate 202.

In the illustrated embodiment, the rear plate 211 may include two second regions 210E that are bent and seamlessly extend from a partial region of the second surface 210B towards the front plate 202. The second regions 210E may be included on both ends of a long edge of the rear plate 211.

In another embodiment, the front plate 202 (or rear plate 211) may include only one of the first regions 210D (or second regions 210E). In another embodiment, the front plate 202 (or rear plate 211) may not include a portion of the first regions 210D (or second regions 210E).

In an embodiment, when viewed from a side of the electronic device 201, the side bezel structure 218 may have a first thickness (or width) in a direction of a side (e.g., short side) not including the first regions 210D or the second regions 210E described above, and may have a second thickness that is smaller than the first thickness in a direction of a side (e.g., long side) including the first regions 210D or the second regions 210E.

In an embodiment, the electronic device 101 may include at least one of a display 206 (e.g., the display module 160 of FIG. 1), audio modules 203 and 207 (e.g., the audio module 170 of FIG. 1), a sensor module (not shown) (e.g., the sensor module 176 of FIG. 1), camera modules 205 and 212 (e.g., the camera module 180 of FIG. 1), a key input device 217 (e.g., the input module 150 of FIG. 1), a light-emitting element (not shown), or a connector hole 208 (e.g., the connection terminal 178 of FIG. 1). In another embodiment, the electronic device 101 may not include at least one of the above components (e.g., the key input device 217 or light-emitting element (not shown)) or may further include other components.

In an embodiment, the display 206 may be exposed through a significant portion of the front plate 202. For example, at least a portion of the display 206 may be exposed through the front plate 202 including the first surface 210A and the first regions 201D of the side surface 210C.

In an embodiment, corners of the display 206 may be formed in a shape that is approximately the same as a shape of an adjacent outer contour of the front plate 202. In another embodiment (not shown), in order to extend an exposed area of the display 206, an outer contour of the display 206 and the outer contour of the front plate 202 may be formed so that a distance therebetween is approximately constant.

In an embodiment, a surface (or front plate 202) of the housing 210 may include a screen display region that is formed since the display 206 is visually exposed. For example, the screen display region may include the first surface 210A and the first regions 210D of the side surface.

In another embodiment (not shown), the screen display regions 210A and 210D may include a sensing region (not shown) configured to obtain biometric information of a user. Here, the wording “screen display regions 210A and 210D include a sensing region” may be construed as meaning that at least a portion of the sensing region may be overlapped on the screen display regions 210A and 210D. For example, the sensing region (not shown) may represent a region in which visual information may be displayed by the display 206 like other regions of the screen display regions 210A and 210D and user's biometric information (e.g., fingerprint) may be further obtained.

In an embodiment, the screen display regions 210A and 210D of the display 206 may include a region in which a first camera module 205 (e.g., punch hole camera) may be visually exposed. For example, at least a portion of an edge of the region in which the first camera module 205 is exposed may be surrounded by the screen display regions 201A and 210D. In an embodiment, the first camera module 205 may include a plurality of camera modules (e.g., the camera module 180 of FIG. 1).

In another embodiment (not shown), the display 206 may be combined with or disposed adjacent to a touch sensing circuit, a pressure sensor capable of measuring strength (pressure) of a touch, and/or a digitizer that detects a magnetic stylus pen.

In an embodiment, audio modules 203, 204, and 207 may include microphone holes 203 and 204 and a speaker hole 207.

In an embodiment, the microphone holes 203 and 204 may include a first microphone hole 203 formed in a partial region of the side surface 210C and a second microphone hole 204 formed in a partial region of the second surface 210B. The microphone holes 203 and 204 may have a microphone disposed therein to obtain an external sound. The microphone may include a plurality of microphones to detect a direction of a sound. In an embodiment, the second microphone hole 204 formed in a partial region of the second surface 210B may be disposed adjacent to the camera modules 205 and 212. For example, the second microphone hole 204 may obtain a sound when the camera modules 205 and 212 are enabled or when another function is executed.

In an embodiment, the speaker hole 207 may include an external speaker hole 207 and a call receiver hole (not shown). The external speaker hole 207 may be formed in a portion of the side surface 201C of the electronic device 101. In another embodiment, the external speaker hole 207 may be implemented as a single hole with the microphone hole 203. Although not illustrated, the call receiver hole (not shown) may be formed in another portion of the side surface 201C. For example, the call receiver hole (not shown) may be formed in another portion (e.g., portion oriented in a direction of +Y axis) of the side surface 201C facing the portion (e.g., portion oriented in a direction of −Y axis) of the side surface 201C in which the external speaker hole 207 is formed.

In an embodiment, the electronic device 101 may include a speaker communicating with the speaker hole 207. In another embodiment, the speaker may include a piezo speaker without the speaker hole 207.

In another embodiment, a sensor module (not shown) (e.g., the sensor module 176 of FIG. 1) may generate an electrical signal or data value corresponding to an internal operation state of the electronic device 101 or an external environment state. For example, the sensor module may include at least one of a proximity sensor, an HRM sensor, a fingerprint sensor, a gesture sensor, a gyro sensor, a barometric pressure sensor, a magnetic sensor, an acceleration sensor, a grip sensor, a color sensor, an infrared (IR) sensor, a biometric sensor, a temperature sensor, a humidity sensor, or an illumination sensor.

In an embodiment, the camera modules 205 and 212 may include a first camera module 205 (e.g., a punch hole camera or an under display camera (UDC)) exposed to the first surface 210A of the electronic device 101, a second camera module 212 exposed to the second surface 210B, and/or a flash 213.

In an embodiment, the first camera module 205 may be exposed through a portion of the screen display regions 210A and 210D of the display 206. For example, the first camera module 205 may be exposed to a partial region of the screen display regions 210A and 210D through an aperture formed in a portion of the display 206.

In an embodiment, the second camera module 212 may include a plurality of camera modules (e.g., a dual camera, triple camera, or quad camera). However, the second camera module 212 does not necessarily include a plurality of camera modules, and may include a single camera module.

The first camera module 205 and the second camera module 212 may include one or more lenses, an image sensor, and/or an image signal processor. The flash 213 may include, for example, a light-emitting diode or xenon lamp. In another embodiments, two or more lenses (an infrared camera, wide-angle and telephoto lenses) and image sensors may be disposed in one surface of the electronic device 101.

In another embodiment, the key input device 217 may be disposed in the side surface 210C (e.g., the first regions 210D) and/or the second regions 210E of the housing 210. In another embodiment, the electronic device 101 may not include a portion or entirety of the key input device 217, and the key input device 217 that is not included may be implemented in other forms such as a soft key or the like on the display 206. In another embodiment, the key input device may include a sensor module (not shown) forming the sensing region (not shown) included in the screen display regions 210A and 210D.

In an embodiment, the connector hole 208 may accommodate a connector. The connector hole 208 may be disposed in the side surface 210C of the housing 210. For example, the connector hole 208 may be disposed in the side surface 210C so as to be adjacent to at least a portion of an audio module (e.g., the microphone hole 203 and speaker hole 207). In another embodiment, the electronic device 101 may include a first connector hole 208 capable of accommodating a connector (e.g., a USB connector) for transmitting and receiving power and/or data to or from an external device and/or a second connector hole (not shown) capable of accommodating a connector (e.g., an earphone jack) for transmitting and receiving an audio signal to or from an external device.

In an embodiment, the electronic device 101 may include a light-emitting element (not shown). For example, the light-emitting element (not shown) may be disposed in the first surface 210A of the housing 110. The light-emitting element (not shown) may provide state information about the electronic device 101 in a form of light. In another embodiment, the light-emitting element (not shown) may provide a light source linked with operation of the first camera module 205. For example, the light-emitting element (not shown) may include an LED, an IR LED, and/or a xenon lamp.

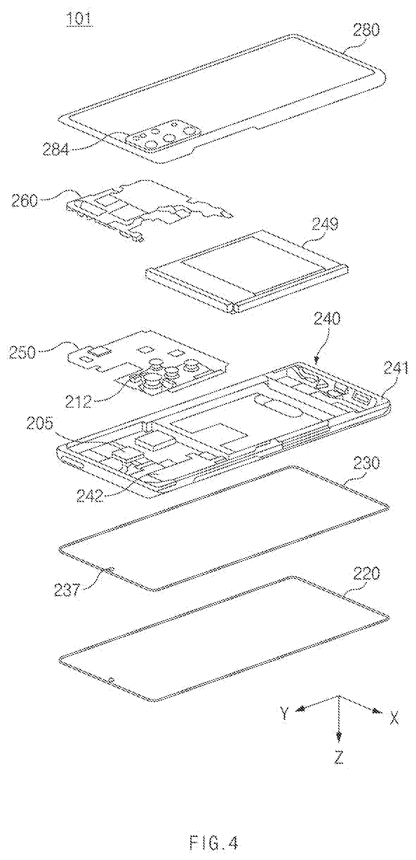

FIG. 4 is an exploded perspective view of an electronic device according to an embodiment.

Referring to FIG. 4, the electronic device 101 may include a front plate 220 (e.g., the frons surface 210A and first region 210D of FIG. 2), a display 230 (e.g., the display 206 of FIG. 2), a bracket 240, a battery 249, a printed circuit board 250, a support member 260 (e.g., rear case), and a rear plate 280 (e.g., the rear surface 210B and second region 210E of FIG. 2).

In another embodiment, the electronic device 101 may not include at least one of the above components (e.g., the support member 260) or may further include other components. At least one of the components of the electronic device 101 may be the same as or similar to at least one of the components of the electronic device 101 of FIG. 2 or 3, and overlapping descriptions are not provided below.

In an embodiment, at least a portion of the front plate 220, the rear plate 280, and the bracket 240 (e.g., frame structure 241) may form a housing (e.g., the housing 210 of FIGS. 2 and 3).

In an embodiment, the bracket 240 may include a frame structure 241 forming a surface (e.g., a portion of the side surface 210C of FIG. 1) of the electronic device 101 and a plate structure 242 extending from the frame structure 241 to the inside of the electronic device 101.

The plate structure 242 may be disposed in the electronic device 101 and may be connected to the frame structure 241 or integrated with the frame structure 241. The plate structure 242 may be formed of, for example, a metallic material and/or non-metallic material (e.g., polymer). The plate structure 242 may have one surface to which the display 230 is coupled and another surface to which the printed circuit board 250 is coupled. The printed circuit board 250 may be mounted with a processor, a memory, and/or an interface. The processor may include, for example, at least one of a central processing unit, an application processor, a graphic processing unit, an image signal processor, a sensor hub processor, or a communication processor.

The memory may include, for example, a volatile memory or a nonvolatile memory.

The interface may include, for example, a high definition multimedia interface (HDMI), a universal serial bus (USB) interface, an SD card interface, and/or an audio interface. The interface, for example, may electrically or physically connect the electronic device 101 to an external device, and may include a USB connector, an SD card, MMC connector, or an audio connector.

In an embodiment, the battery 249 may supply power to at least one of the components of the electronic device 101. For example, the battery 249 may include a primary cell which is not rechargeable, a secondary cell which is rechargeable, or a fuel cell. In an embodiment, at least a portion of the battery 249 may be substantially flush with the printed circuit board 250. In an embodiment, the battery 249 may be integrally disposed in the electronic device 101 or may be disposed so as to be detachable from the electronic device 101.

In an embodiment, the first camera module 205 may be disposed in the plate structure 242 of the bracket 240 so that a lens is exposed to a partial region of the front plate 220 (e.g., the front surface 210A of FIG. 1) of the electronic device 101.

In an embodiment, the first camera module 205 may be disposed so that an optical axis of a lens is at least partially aligned with a hole or recess 237 formed in the display 230. For example, a region in which the lens is exposed may be formed in the front plate 220. For example, the first camera module 205 may include a punch hole camera, at least a portion of which is disposed in the hole or recess 237 formed in a rear surface of the display 230. For another example, additionally or alternatively, the first camera module 205 may include an under display camera (UDC) disposed in a space under the display 230 (e.g., e.g., a space from the display 230 towards the inside of the electronic device 101).

In an embodiment, the second camera module 212 may be disposed on the printed circuit board 250 so that a lens is exposed to a camera region 284 of the rear plate 280 (e.g., the rear surface 210B of FIG. 3) of the electronic device 101.

In an embodiment, the camera region 284 may be disposed on a surface (e.g., the rear surface 210B of FIG. 3) of the rear plate 280. In an embodiment, the camera region 284 may be at least partially transparently formed so that external light may be incident on a lens of the second camera module 212. In an embodiment, at least a portion of the camera region 284 may protrude to a predetermined height from the surface of the rear plate 280. However, an embodiment is not necessarily limited thereto, and the camera region 284 may form a plane that is substantially the same as the surface of the rear plate 280.

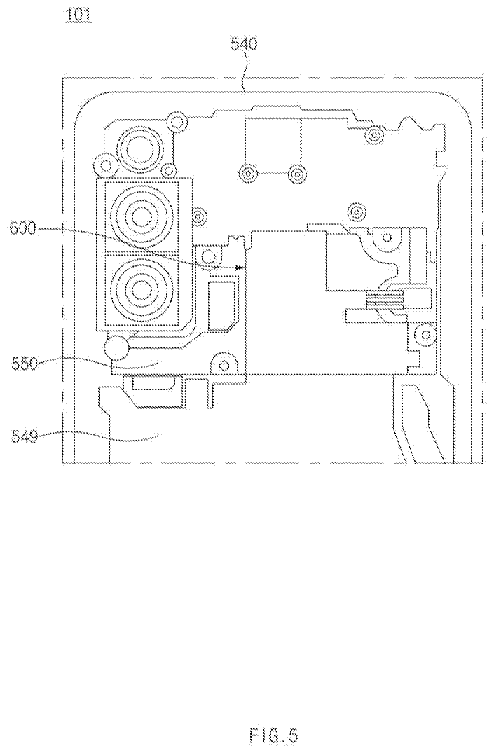

FIG. 5 is a plan view illustrating an interior of the electronic device 101 according to an embodiment.

According to an embodiment, the electronic device 101 (e.g., the electronic device 101 of FIG. 1) may include a side member 540 (e.g., the side bezel structure 218 of FIG. 2 or the frame structure 241 of FIG. 4). For example, the side member 540 may include a first plate (e.g., the front plate 220 of FIG. 4) oriented in a first direction (e.g., +z direction of FIG. 4), a second plate (e.g., the rear plate 280 of FIG. 4) oriented in a second direction (e.g., −z direction of FIG. 4) opposite to the first direction, and a housing (e.g., the housing 210 of FIGS. 2 and 3) surrounding a space between the first plate and the second plate. For example, the side member 540 may be integrally formed with the first plate and/or the second plate, or may be physically divided therefrom and separately formed. Meanwhile, the internal mounting structure of the electronic device 101 illustrated in FIG. 5 may be a plan view when the rear plate (e.g., the rear plate 280 of FIG. 4) of the electronic device 101 is seen in the first direction. For example, the electronic device 101 may include various components in a mounting space inside the housing (e.g., the housing 210 of FIGS. 2 and 3).

According to an embodiment, the electronic device 101 may include a battery 549 (e.g., the battery 249 of FIG. 4) in the housing. In an embodiment, at least a portion of the battery 549 may be substantially flush with the printed circuit board 550, but embodiments of the disclosure are not limited thereto. In an embodiment, the battery 549 may be integrally disposed in the electronic device 101 or may be disposed so as to be detachable from the electronic device 101.

According to an embodiment, the electronic device 101 may include the printed circuit board 550 (e.g., the printed circuit board 250 of FIG. 4). The printed circuit board 550 may be, for example, a flexible printed circuit board (FPCB). The printed circuit board 550 may be disposed on one surface of a support member (e.g., the support member 260 of FIG. 4) disposed in a space between the front plate (e.g., the front plate 220 of FIG. 4) and the rear plate (e.g., the rear plate 280 of FIG. 4). For example, the one surface of the support member on which the printed circuit board 550 is disposed may be referred to as one surface oriented in the first direction (e.g., +z direction of FIG. 4) on the support member.

According to an embodiment, the electronic device 101 may further include a processor (e.g., the processor 120 of FIG. 1) operatively connected to the printed circuit board 550 and an antenna structure. Various components (e.g., antenna structure and/or wireless communication circuit) may be disposed on the printed circuit board 550. For example, an antenna structure may be mounted on the printed circuit board 550. The antenna structure mounted on the printed circuit board 550 may be operatively connected to the processor.

The arrangement structure described above based on the side member 540, the battery 549, the printed circuit board 550, and a region corresponding to reference number 600, as illustrated in FIG. 5, is merely an example, and embodiments of the disclosure are not limited thereto. For example, an additional printed circuit board may be further disposed in the housing of the electronic device 101.

Hereinafter, a laminate structure of the antenna structure disposed in the region corresponding to reference number 600 and components included in the antenna structure will be described in more detail.

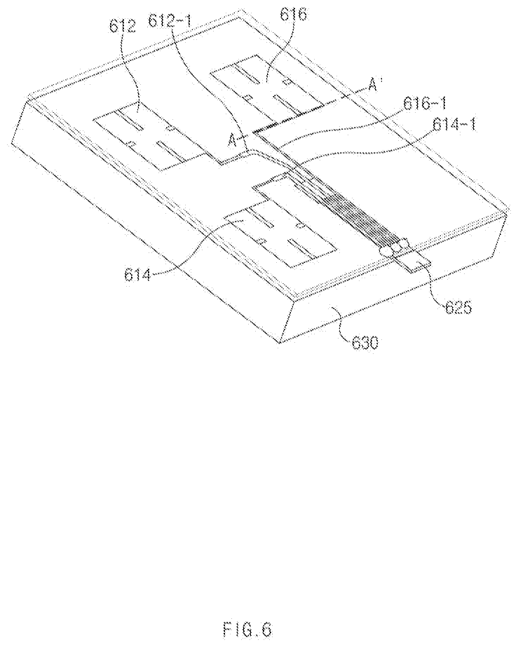

FIG. 6 is a perspective view illustrating an antenna structure and components included in the antenna structure according to an embodiment.

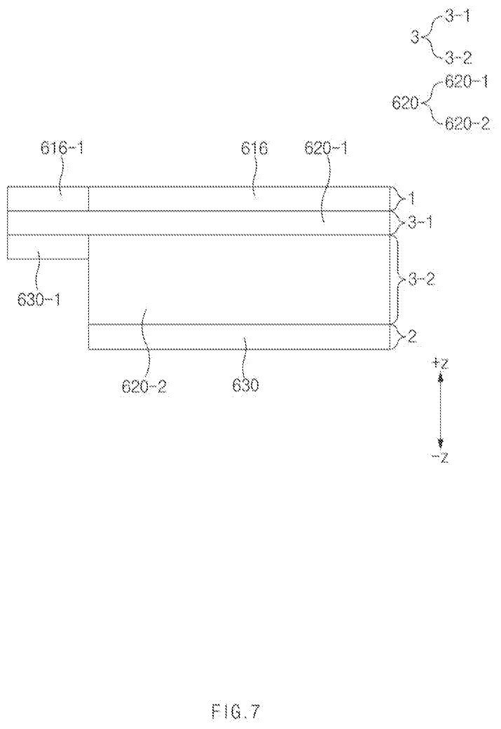

Referring to FIGS. 6 and 7, according to an embodiment, the antenna structure may include a laminate structure divided into a plurality of layers. For example, the antenna structure may include the laminate structure divided into a first layer 1, a second layer 2, and a third layer 3, and may be implemented with various components disposed in each of the layers. The third layer 3, for example, may be divided into a 3-1st layer 3-1 and a 3-2nd layer 3-2. For example, the antenna structure may include a first conductive patch 612, a second conductive patch 614, a third conductive patch 616, a first transmission line 612-1, a second transmission line 614-1, a third transmission line 616-1, a dielectric 620, a connection part 625, and a shielding member 630. The dielectric 620, for example, may include a first dielectric 620-1 and a second dielectric 620-2.

According to an embodiment, the first conductive patch 612, the second conductive patch 614, and the third conductive patch 616 may be disposed at the first layer 1 of the antenna structure. In an embodiment, the first conductive patch 612, the second conductive patch 614, and the third conductive patch 616 may be disposed on the dielectric 620. In an embodiment, the first conductive patch 612, the second conductive patch 614, and the third conductive patch 616 may be spaced apart from each other. In an embodiment, the first conductive patch 612, the second conductive patch 614, and the third conductive patch 616 may include a conductive material such as a metal foil. In an embodiment, the first conductive patch 612, the second conductive patch 614, and the third conductive patch 616 may be formed through various types of plating processes. For example, the first conductive patch 612, the second conductive patch 614, and the third conductive patch 616 may be formed by laser direct structuring (LDS). In an embodiment, the first conductive patch 612, the second conductive patch 614, and the third conductive patch 616 may be referred to as a conductive pattern formed on the dielectric 620. In other words, the first conductive patch 612, the second conductive patch 614, and the third conductive patch 616 may be a conductive pattern formed on a first surface, oriented in the first direction (e.g., +z direction of FIG. 4), of the dielectric 620 disposed at the third layer 3. In an embodiment, the first conductive patch 612, the second conductive patch 614, and the third conductive patch 616 may have a square shape, rectangular shape, rhombic shape, or circular shape.

In an embodiment, the second conductive patch 614 and the third conductive patch 616 may be disposed to be spaced a specified distance apart from the first conductive patch 612. For example, the second conductive patch 614 may be disposed to be spaced a first separation distance apart from the first conductive patch 612 in a third direction (e.g., −x direction of FIG. 4). The third direction may be referred to as a direction perpendicular to the first direction and the second direction and facing the outside of the electronic device. The first separation distance may be referred to as a physical distance between a geometric center of the first conductive patch 612 and a geometric center of the second conductive patch 614. For another example, the third conductive patch 616 may be disposed to be spaced a second separation distance apart from the first conductive patch 612 in a fourth direction (e.g., +y direction of FIG. 4). The fourth direction may be referred to as a direction perpendicular to the first direction, the second direction, and the third direction and facing the outside of the electronic device. The second separation distance may be referred to as a physical distance between a geometric center of the first conductive patch 612 and a geometric center of the third conductive patch 616. In an embodiment, the separation distance between the first conductive patch 612 and the second conductive patch 614 and the separation distance between the first conductive patch 612 and the third conductive patch 616 may be substantially the same. In other words, the first separation distance and the second separation distance may be substantially the same.

According to an embodiment, the first transmission line 612-1, the second transmission line 614-1, and the third transmission line 616-1 may be disposed at the first layer 1 of the antenna structure. For example, the first transmission line 612-1, the second transmission line 614-1, and the third transmission line 616-1 may be disposed on the dielectric 620. In an embodiment, the first transmission line 612-1, the second transmission line 614-1, and the third transmission line 616-1 may include a conductive material (e.g., copper). In an embodiment, the first transmission line 612-1, the second transmission line 614-1, and the third transmission line 616-1 may be electrically connected to the first conductive patch 612, the second conductive patch 614, and the third conductive patch 616, respectively. In an embodiment, the first conductive patch 612 may be electrically connected to external components (e.g., wireless communication circuit) through the first transmission line 612-1. For example, the first conductive patch 612 may be fed from a wireless communication circuit through the first transmission line 612-1. In an embodiment, the second conductive patch 614 may be electrically connected to external components (e.g., wireless communication circuit) through the second transmission line 614-1. For example, the second conductive patch 614 may be fed from a wireless communication circuit through the second transmission line 614-1. In an embodiment, the third conductive patch 616 may be electrically connected to external components (e.g., wireless communication circuit) through the third transmission line 616-1. For example, the third conductive patch 616 may be fed from a wireless communication circuit through the third transmission line 616-1. The first conductive patch 612, the second conductive patch 614, and the third conductive patch 616 may receive a signal of a specified band.

According to an embodiment, the antenna structure may include the connection part 625 disposed at the first layer 1. The connection part 625 may be disposed so as to protrude from one side of the antenna structure when the rear plate (e.g., the rear plate 280 of FIG. 4) is seen in the first direction. For example, the connection part 625 may be electrically connected to the first transmission line 612-1, the second transmission line 614-1, the third transmission line 616-1, and the printed circuit board. In an embodiment, the electronic device (e.g., the electronic device 101 of FIG. 1) may cause a processor (e.g., the processor 120 of FIG. 1) to feed the connection part 625 through a wireless communication circuit disposed on the printed circuit board. In other words, the electronic device may control the processor to feed the first conductive patch 612, the second conductive patch 614, and the third conductive patch 616 respectively through the first transmission line 612-1, the second transmission line 614-1, and the third transmission line 616-1 electrically connected to the connection part 625.

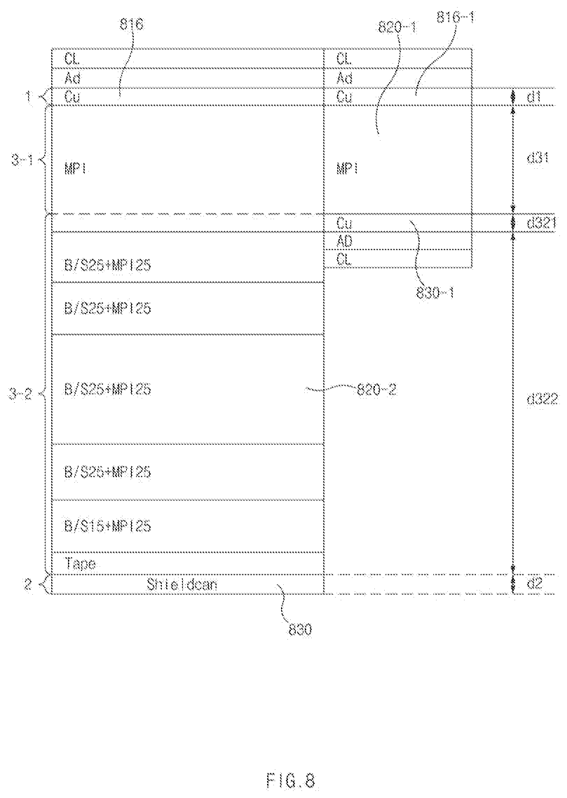

According to an embodiment, the antenna structure may include the shielding member 630 disposed at the second layer 2. For example, the shielding member 630 may be disposed under the dielectric 620. For another example, the shielding member 630 may be coupled to one surface of the dielectric 620. In other words, the shielding member 630 may be disposed on a second surface, oriented in the second direction (e.g., −z direction of FIG. 4), of the dielectric 620 disposed at the third layer 3. In an embodiment, the shielding member 630 may include a conductive material such as metal. For example, the shielding member 630 may include a conductive metal having substantially a plate shape. For example, at least a portion of the shielding member 630 may be a shield can. In an embodiment, the shield can may be disposed by being attached to one surface of the printed circuit board (e.g., the printed circuit board 550 of FIG. 5) on which a plurality of conductive patches included in the electronic device are mounted and/or disposed. For example, the electronic device may ground the plurality of patches by using the shielding member based on a mounting structure in which the shielding member including the shield can is attached to one surface of the printed circuit board. The plurality of conductive patches may be electrically connected to the shielding member based on various schemes. For example, the plurality of conductive patches may be electrically connected to the shielding member based on a connector type, interpose type, and/or solder surface-mount devices (SMD) type. A member that electrically connects the plurality of conductive patches and the shielding member may be referred to as a tape layer (Tape) included in the 3-2nd layer 3-2 of FIG. 8 that will be described later. In an embodiment, the shielding member 630 may be physically spaced apart from the conductive patches 612, 614, and 616, and may be disposed substantially in parallel with the conductive patches 612, 614, and 616. In an embodiment, the conductive patches 612, 614, and 616 may be grounded by the shielding member 630. In other words, the shielding member 630 may correspond to a ground region for the conductive patches 612, 614, and 616.

According to an embodiment, the antenna structure may include the dielectric 620 disposed at the third layer 3. For example, the third layer 3 may be referred to as a layer between the first layer 1 and the second layer 2. In an embodiment, the dielectric 620 may be disposed between the conductive patches 612, 614, and 616 and the shielding member 630. In an embodiment, permittivity and/or thickness of the dielectric 620 may be determined according to required radiation characteristics (e.g., radiation efficiency and/or bandwidth) of an antenna.

FIG. 7 is a conceptual diagram illustrating a laminate structure of an antenna structure according to an embodiment.

Referring to FIG. 7, the antenna structure may include a laminate structure divided into a plurality of layers according to an embodiment. For example, the antenna structure may include the laminate structure divided into the first layer 1, the second layer 2, and the third layer 3 (e.g., 3-1st layer 3-1, 3-2nd layer 3-2) (e.g., the third layer 3 of FIG. 6), and may be implemented with various components disposed in each of the layers. For example, the antenna structure may include the third conductive patch 616, the third transmission line 616-1, the dielectric 620 (e.g., a first dielectric 620-1 and a second dielectric 620-2), the shielding member 630, and/or a ground region 630-1.

According to an embodiment, the first layer 1 may include a plurality of conductive patches (e.g., the first conductive patch 612, the second conductive patch 614, and the third conductive patch 616 of FIG. 6) and a plurality of transmission lines (e.g., the first conductive line 612-1, the second transmission line 614-1, and the third transmission line 616-1 of FIG. 6). At least a portion of the plurality of conductive patches and the plurality of transmission lines may be disposed on the first dielectric 620-1. In an embodiment, the first conductive patch 612, the second conductive patch 614, and the third conductive patch 616 may be spaced apart from each other.

According to an embodiment, the second layer 2 may include the shielding member 630. For example, the shielding member 630 may be disposed under the second dielectric 620-2 included in the 3-2nd layer 3-2. For another example, the shielding member 630 may be coupled to one surface of the second dielectric 620-2. In other words, the shielding member 630 may be disposed on a second surface, oriented in the second direction (e.g., −z direction of FIG. 4), of the second dielectric 620-2 disposed at the 3-2nd layer 3-2. In an embodiment, the shielding member 630 may include a conductive material such as metal. For example, the shielding member 630 may include a conductive metal having substantially a plate shape.

According to an embodiment, the third layers 3-1 and 3-2 may include a 3-1st layer 3-1 and a 3-2nd layer 3-2. The 3-1st layer 3-1 may include the first dielectric 620-1. The 3-2nd layer 3-2 may include the second dielectric 620-2 and/or the ground region 630-1. The ground region 630-1, for example, may provide ground to at least a portion of the plurality of transmission lines (e.g., the first transmission line 612-1, the second transmission line 614-1, and the third transmission line 616-1 of FIG. 6). For example, the first dielectric 620-1 and/or the second dielectric 620-2 may include a polyimide (PI) film, modified PI (MPI) film, and/or preimpregnated materials (Prepreg, PPG) layer. For another example, the first dielectric 620-1 and/or the second dielectric 620-2 may further include a bonding sheet (B/S) layer. For example, the first dielectric 620-1 and/or the second dielectric 620-2 may include a laminate structure in which a plurality of components are attached using the B/S layer. For another example, the second dielectric layer 620-2 may include an adhesive member. For example, the second dielectric 620-2 may be fixed to an external component (e.g., the shielding member 630 of FIGS. 6 and 7 or the shielding member 830 of FIG. 8) through a tape-type adhesive member.

FIG. 8 is a conceptual diagram illustrating a laminate structure of an antenna structure according to an embodiment.

Referring to FIG. 8, the antenna structure may be divided into a laminate structure including various components according to an embodiment. For example, the antenna structure may be divided into the laminate structure including a first layer (e.g., the first layer 1 of FIG. 7), a second layer (e.g., the second layer 2 of FIG. 7), a 3-1st layer (e.g., the 3-1st layer of FIG. 7), and a 3-2nd layer (e.g., the 3-2nd layer 3-2 of FIG. 7).

According to an embodiment, the antenna structure may include a coverlay (CL) layer and an adhesive (Ad) layer. For example, the antenna structure may include the CL (e.g., PI film) layer and the Ad layer formed in the first direction (e.g., +z direction of FIG. 4) from the first layer 1. The antenna structure may prevent an oxidation phenomenon due to contact with the outside using the CL layer and the Ad layer.

According to an embodiment, the antenna structure may include the shielding member 830 disposed at the second layer 2. A thickness d2 of the second layer 2 including the shielding member 830 may be about 100 μm. The shielding member 830, for example, may be a shield can. A plurality of antenna elements (e.g., the first conductive patch 612, the second conductive patch 614, and the third conductive patch 616 of FIG. 6) included in the antenna structure may be grounded by the shielding member 830.

According to an embodiment, the antenna structure may further include various components laminated in the first direction (e.g., +z direction of FIG. 4 and/or +z direction of FIG. 7) from the shielding member 830. In an embodiment, a layer laminated in the first direction (e.g., +z direction of FIG. 4 and/or +z direction of FIG. 7) of the second layer 2 may be defined as the first layer 1 (e.g., the first layer 1 of FIG. 7). For example, in the first layer 1 of the antenna structure, at least one of the plurality of conductive patches 816 (e.g., the first conductive patch 612, the second conductive patch 614, and the third conductive patch 616 of FIG. 6), the plurality of transmission lines 816-1 (e.g., the first transmission line 612-1, the second transmission line 614-1, and the third transmission line 616-1 of FIG. 6), or a connection part (e.g., the connection part 615 of FIG. 6). For example, a thickness d1 of the first layer 1 may be about 20 μm.

According to an embodiment, layers laminated between the first layer 1 and the second layer 2 may be defined as a 3-1st layer 3-1 (e.g., the 3-1st layer 3-1 of FIG. 7) and a 3-2nd layer 3-2 (e.g., the 3-2nd layer 3-2 of FIG. 7). For example, a first dielectric 820-1 (e.g., the first dielectric 620-1 of FIG. 7) may be disposed at the 3-1st layer 3-1. A thickness d31 of the first dielectric 820-1 may be about 100 μm. For another example, a ground region 830-1 and a second dielectric 820-2 (e.g., the second dielectric 620-2 of FIG. 7) may be disposed at the 3-2nd layer 3-2. A thickness d321 of the ground region 830-1 may be about 6 μm. The ground region 830-1, for example, may provide ground to at least a portion of the plurality of transmission lines (e.g., the first transmission line 612-1, the second transmission line 614-1, and the third transmission line 616-1 of FIG. 6). In an embodiment, the Ad layer and CL layer may be further disposed in the second direction (e.g., −z direction of FIG. 4) from the ground region 830-1. The above descriptions about the Ad layer and CL layer may apply. A thickness d322 of the second dielectric 820-2 may be about 300 μm to about 320 μm. In an embodiment, the first dielectric 820-1 and/or the second dielectric 820-2 may include a polyimide (PI) film, modified PI (MPI) film, and/or prepreg (PPG) layer. The first dielectric 820-1 and/or the second dielectric 820-2 may further include a bonding sheet (B/S) layer. For example, the first dielectric 820-1 and/or the second dielectric 820-2 may include a laminate structure in which a plurality of components are attached using the B/S layer. For example, a thickness (e.g., thickness d31, thickness d321, and thickness d322) of a dielectric related to characteristics of the antenna structure may be formed by repeatedly laminating the PI film (e.g., MPI) and the B/S layer. For another example, the second dielectric layer 820-2 may include an adhesive member (e.g., tape). The second dielectric 820-2 may be fixed to the shielding member 830 through a tape-type adhesive member.

Referring to FIG. 8, the electronic device according to an embodiment of the disclosure may reduce a thickness of the laminate structure and/or the number of layers thereof by grounding by using the shielding member 830 (e.g., shield can) attached to one surface of the printed circuit board, without a laminate region (e.g., the ground regions 630-1, 830-1) in which a ground part of a plurality of conductive patches is disposed. Accordingly, the electronic device may operate based on improved radiation performance by securing a patch antenna structure with an extended or increased thickness by further securing a space in which a plurality of patch antennas are disposed in the antenna structure.

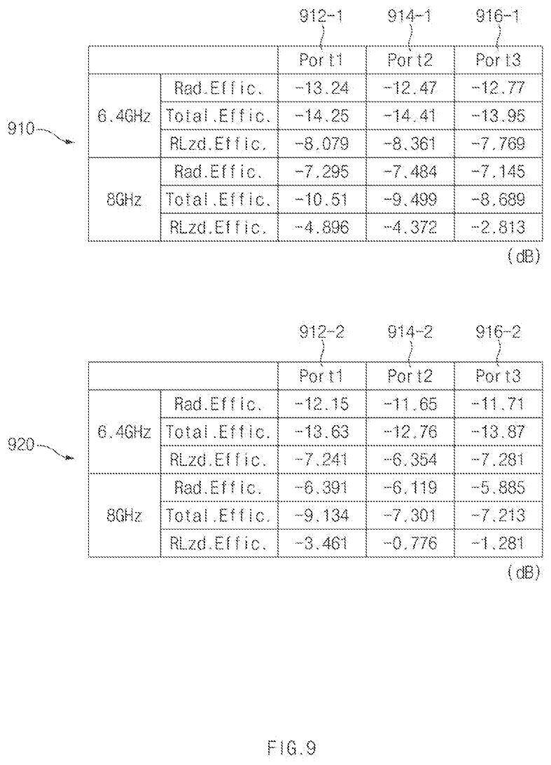

FIG. 9 illustrates a radiation efficiency comparison table of an antenna structure according to an embodiment.

Referring to FIG. 9, according to an embodiment of the disclosure, an electronic device (e.g., the electronic device 101 of FIG. 1) may secure improved radiation efficiency based on the above-mentioned laminate structure. Reference number 910 is a table showing radiation efficiency of an electronic device according to conventional technology. Reference number 920 is a table showing radiation efficiency of an electronic device including a laminate structure according to an embodiment of the disclosure.

According to an embodiment, the electronic device according to conventional technology exhibits radiation efficiency corresponding to the table referred to by reference number 910 in each of 6.4 GHz band and 8 GHz band. For example, a first conductive patch 912-1, a second conductive patch 914-1, and a third conductive patch 916-1 of the electronic device according to conventional technology respectively exhibit radiation efficiency of −13.24 dB, −12.47 dB, and −12.77 dB in a 6.4 GHz band.

According to an embodiment, the electronic device according to an embodiment exhibits radiation efficiency corresponding to the table referred to by reference number 920 in each of 6.4 GHz band and 8 GHz band. For example, a first conductive patch 912-2 (e.g., the first conductive patch 612 of FIG. 6), a second conductive patch 914-2 (e.g., the second conductive patch 614 of FIG. 6), and a third conductive patch 916-2 (e.g., the third conductive patch 616 of FIG. 6) of the electronic device according to an embodiment respectively exhibit radiation efficiency of −12.15 dB, −11.65 dB, and −11.71 dB in a 6.4 GHz band.

Referring to the tables of reference number 910 and reference number 920, it may be confirmed that the electronic device according to an embodiment secures radiation efficiency improved by as much as about 1 dB compared to the electronic device according to conventional technology. In detail, the electronic device may efficiently prevent deterioration of radiation characteristics and improve the performance of radiation operation performed in a frequency band of a specified band (e.g., 6.4 GHz and 8 GHz) by grounding a plurality of conductive patches through a shielding member (e.g., the shielding member 630 of FIGS. 6 and 7) attached to one surface of a printed circuit board (e.g., the printed circuit board of FIG. 5).

An electronic device according to an embodiment of the disclosure may comprise: a housing comprising a first plate oriented in a first direction, a second plate oriented in a second direction opposite to the first direction, and a side member surrounding a space between the first plate and the second plate; a support member disposed in the space between the first plate and the second plate; a printed circuit board disposed on one surface of the support member and including a wireless communication circuit; an antenna structure disposed on the printed circuit board; and a processor operatively connected to the printed circuit board and the antenna structure. For example, the antenna structure may include a first conductive patch disposed at a first layer and electrically connected to a first transmission line, a second conductive patch disposed to be spaced apart from the first conductive patch in the first layer and electrically connected to a second transmission line, a third conductive patch disposed to be spaced apart from the first conductive patch and the second conductive patch in the first layer and electrically connected to a third transmission line, and a shielding member disposed at a second layer, and the processor may be configured to receive a wireless signal of a specified band by feeding the first conductive patch, the second conductive patch, and the third conductive patch using the wireless communication circuit.

According to an embodiment, the printed circuit board may correspond to a flexible printed circuit board (FPCB).

According to an embodiment, the antenna structure may further include a dielectric disposed at a third layer that is a layer between the first layer and the second layer.

According to an embodiment, the first conductive patch, the second conductive patch, and the third conductive patch may be a conductive pattern formed on a first surface, oriented in the first direction, of the dielectric disposed at the third layer.

According to an embodiment, the shielding member may be disposed on a second surface, oriented in the second direction, of the dielectric disposed at the third layer.

According to an embodiment, the antenna structure may further include a connection member disposed between the shielding member and the dielectric and coupling the shielding member and the dielectric.

According to an embodiment, the first layer and the third layer may have a thickness of 420 μm to 450 μm.

According to an embodiment, the first transmission line, the second transmission line, and the third transmission line may have a thickness of 20 μm.

According to an embodiment, the first conductive patch, the second conductive patch, and the third conductive patch may be formed by laser direct structuring (LDS).

According to an embodiment, the first conductive patch, the second conductive patch, and the third conductive patch may have a square shape or rectangular shape.

According to an embodiment, the shielding member may be a shield can.

According to an embodiment, the shielding member may be disposed so as to be physically attached to the printed circuit board, and the first conductive patch, the second conductive patch, and the third conductive patch may be grounded by the shielding member.

According to an embodiment, the second conductive patch may be disposed to be spaced a first separation distance apart from the first conductive patch in a third direction, and the third conductive patch may be disposed to be spaced a second separation distance apart from the first conductive patch in a fourth direction perpendicular to the third direction.

According to an embodiment, the antenna structure may further include a connection part electrically connected to the printed circuit board, the first transmission line, the second transmission line, and the third transmission line, and the processor may be configured to feed the connection part using the wireless communication circuit.

According to an embodiment, the connection part may be disposed so as to protrude from one side of the antenna structure when the rear plate is seen in the first direction.

An electronic device according to an embodiment of the disclosure may comprise: a housing comprising a first plate oriented in a first direction, a second plate oriented in a second direction opposite to the first direction, and a side member surrounding a space between the first plate and the second plate; a support member disposed in the space between the first plate and the second plate; a flexible printed circuit board (FPCB) disposed on one surface of the support member and including a wireless communication circuit; an antenna structure disposed on the FPCB; and a processor operatively connected to the FPCB and the antenna structure. For example, the antenna structure may comprise a first conductive patch disposed at a first layer and electrically connected to a first transmission line, a second conductive patch disposed to be spaced apart from the first conductive patch in the first layer and electrically connected to a second transmission line, a third conductive patch disposed to be spaced apart from the first conductive patch and the second conductive patch in the first layer and electrically connected to a third transmission line, a shielding member disposed at a second layer; and a dielectric disposed at a third layer that is a layer between the first layer and the second layer, wherein the first conductive patch, the second conductive patch, and the third conductive patch may correspond to a conductive pattern formed on a first surface, oriented in the first direction, of the dielectric disposed at the third layer, the shielding member may be disposed on a second surface, oriented in the second direction, of the dielectric disposed at the third layer, and the processor may be configured to receive a wireless signal of a specified band by feeding the first conductive patch, the second conductive patch, and the third conductive patch using the wireless communication circuit.

According to an embodiment, the first conductive patch, the second conductive patch, and the third conductive patch may have a square shape or rectangular shape.

According to an embodiment, the shielding member may be a shield can.

According to an embodiment, the shielding member may be disposed so as to be physically attached to the FPCB, and the first conductive patch, the second conductive patch, and the third conductive patch may be grounded by the shielding member.

According to an embodiment, the second conductive patch may be disposed to be spaced a first separation distance apart from the first conductive patch in a third direction, and the third conductive patch may be disposed to be spaced a second separation distance apart from the first conductive patch in a fourth direction perpendicular to the third direction.

An antenna structure comprising a plurality of layers according to an embodiment of the disclosure may comprise: a first conductive patch disposed at a first layer among the plurality of layers and electrically connected to a first transmission line; a second conductive patch disposed to be spaced apart from the first conductive patch in the first layer and electrically connected to a second transmission line; a third conductive patch disposed to be spaced apart from the first conductive patch and the second conductive patch in the first layer and electrically connected to a third transmission line; a shielding member disposed at a second layer among the plurality of layers; a connection part electrically connected to the first transmission line, the second transmission line, and the third transmission line; and a dielectric disposed at a third layer that is a layer between the first layer and the second layer.

According to an embodiment, the first conductive patch, the second conductive patch, and the third conductive patch may have a square shape or a rectangular shape.

According to an embodiment, the shielding member may be a shield can.

According to an embodiment, one surface of the shielding member may be disposed so as to be physically attached to a printed circuit board, and the first conductive patch, the second conductive patch, and the third conductive patch may be grounded by the shielding member.

According to an embodiment, the second conductive patch may be spaced a first separation distance apart from the first conductive patch in a third direction, and the third conductive patch may be disposed to be spaced a second separation distance apart from the first conductive patch in a fourth direction perpendicular to the third direction.

What is claimed is:

1. An electronic device comprising:
a housing comprising:
a first plate oriented in a first direction,
a second plate oriented in a second direction opposite to the first direction, and
a side member surrounding a space between the first plate and the second plate;
a support member disposed in the space between the first plate and the second plate;
a printed circuit board disposed on one surface of the support member and comprising a wireless communication circuit;
an antenna disposed on the printed circuit board; and
a processor operatively connected to the printed circuit board and the antenna,
wherein the antenna comprises:
a first conductive patch disposed at a first layer and electrically connected to a first transmission line;
a second conductive patch configured to be spaced apart from the first conductive patch at the first layer and electrically connected to a second transmission line;
a third conductive patch configured to be spaced apart from the first conductive patch and the second conductive patch at the first layer, and electrically connected to a third transmission line; and
a shielding member disposed at a second layer, and
wherein the processor is configured to receive a wireless signal of a specified band by feeding the first conductive patch, the second conductive patch, and the third conductive patch using the wireless communication circuit.

2. The electronic device of claim 1,
wherein the antenna further comprises a dielectric disposed at a third layer that is between the first layer and the second layer.

3. The electronic device of claim 2,
wherein the first conductive patch, the second conductive patch, and the third conductive patch form a conductive pattern on a first surface, oriented in the first direction, of the dielectric disposed at the third layer.

4. The electronic device of claim 2,
wherein the shielding member is disposed on a second surface, oriented in the second direction, of the dielectric disposed at the third layer.

5. The electronic device of claim 1,
wherein the first conductive patch, the second conductive patch, and the third conductive patch have a square shape or a rectangular shape.

6. The electronic device of claim 1,
wherein the shielding member is a shield can.

7. The electronic device of claim 1,
wherein the shielding member is configured to be physically attached to the printed circuit board, and
wherein the first conductive patch, the second conductive patch, and the third conductive patch are grounded by the shielding member.

8. The electronic device of claim 1,
wherein the second conductive patch is configured to be spaced a first separation distance apart from the first conductive patch in a third direction, and
wherein the third conductive patch is configured to be spaced a second separation distance apart from the first conductive patch in a fourth direction perpendicular to the third direction.

9. The electronic device of claim 1,
wherein the antenna further comprises a connection part electrically connected to the printed circuit board, the first transmission line, the second transmission line, and the third transmission line, and
wherein the processor is configured to feed the connection part using the wireless communication circuit.

10. The electronic device of claim 9,
wherein the connection part is configured to protrude from one side of the antenna when the second plate is seen in the first direction.

11. An antenna comprising:
a plurality of layers;
a first conductive patch disposed at a first layer among the plurality of layers and electrically connected to a first transmission line;
a second conductive patch configured to be spaced apart from the first conductive patch in the first layer and electrically connected to a second transmission line;
a third conductive patch configured to be spaced apart from the first conductive patch and the second conductive patch in the first layer, and electrically connected to a third transmission line;
a shielding member disposed at a second layer among the plurality of layers;
a connection part electrically connected to the first transmission line, the second transmission line, and the third transmission line; and
a dielectric disposed at a third layer that is a layer between the first layer and the second layer.

12. The antenna of claim 11,
wherein the first conductive patch, the second conductive patch, and the third conductive patch have a square shape or a rectangular shape.

13. The antenna of claim 11,
wherein the shielding member is a shield can.

14. The antenna of claim 11,
wherein one surface of the shielding member is configured to be physically attached to a printed circuit board, and
wherein the first conductive patch, the second conductive patch, and the third conductive patch are grounded by the shielding member.

15. The antenna of claim 11,
wherein the second conductive patch is configured to be spaced a first separation distance apart from the first conductive patch in a third direction, and
wherein the third conductive patch is configured to be spaced a second separation distance apart from the first conductive patch in a fourth direction perpendicular to the third direction.
